(19) United States
(12) Patent Application Publication
(10) Pub. No.: US 2005/0158018 A1
(43) Pub. Date: Jul. 21, 2005

(54) Information reproduction apparatus

(75) Inventor: Akihiro Sawada, Hyogo (JP)

Correspondence Address: OLIFF & BERRIDGE, PLC, P.O. BOX 19928, ALEXANDRIA, VA, 22320, US

(73) Assignee: FUJITSU TEN LIMITED, Kobe-shi (JP)

(21) Appl. No.: 11/036,022

(22) Filed: Jan. 18, 2005

(30) Foreign Application Priority Data
Jan. 19, 2004 (JP) 2004-009979

(51) Int. Cl. H04N 5/76; H04N 5/781

(52) U.S. Cl. 386/46; 386/125

(57) ABSTRACT

An information reproduction apparatus includes a button, a memory, a detection section, a storage section that stores information, a reproduction section, and a control section. The memory has a storage region corresponding to the button. The detection section detects which way the button is pressed in, from among predetermined ways including a first way and a second way. The reproduction section reproduces the information stored in the storage section. When the button is pressed while the reproduction section reproduces the information and the detection section detects that the button is pressed in the first way, the control section store subinformation of the information being reproduced in the storage region corresponding to the pressed button. When the button is pressed and the detection section detects that the button is pressed in the second way, the control section reads out subinformation stored in the storage region corresponding to the pressed button.

### BACKGROUND OF THE INVENTION

1. Field of the Invention

The invention relates to an information reproduction apparatus such as a music player and a compressed-motion-picture reproduction apparatus, and particularly relates to an information reproduction apparatus capable of reading a desired piece of information from a large number of pieces of information stored in a storage device or a recording medium.

2. Description of the Related Art

A music player, for example, an audio player for playing audio data compressed in the MP 3 (MPEG 1 Audio Layer 3) format can compress audio data to about 1/11 of CD with substantially keeping the same quality as a CD, so that the audio player can record audio data, which is 11 times as large as a CD, into a CD. That is, such audio player can record about 150 songs in a CD.

Further, an in-vehicle audio apparatus has a recording medium reproduction apparatus such as a CD player so that a passenger can enjoy, through a music reproduction system, music reproduced by the reproduction apparatus. The in-vehicle audio apparatus also has a large capacity hard disk (hereinafter referred to as HD) of e.g. several tens G (giga) bytes and a hard disk drive (hereinafter referred to as HDD) for driving the HD so that a large number of recording media such as CDs has been copied into the HD in advance and the passenger can select any music program from the HD and enjoy music reproduced through the music reproduction system (for example, JP-A-2000-207845).

If compressed audio data are recorded in the HD as described above, a limitless number, e.g. several thousand pieces of music or songs can be recorded. Such a large number of pieces of music contain pieces of music of a large number of performers and belong to various genres. In this case, it is difficult to select a desired piece of music from the large number of music recorded.

On the other hand, the MP3 format includes a format in which a data region having a fixed length of 128 bytes is added to an end of the MP3 file. In this format, it is possible to embed adjunct character information (ID tag information) such as a music name, an album name, and a performer name into the data region.

Where a user stores a large number of pieces of music into a recording medium, the ID tag information is used. Specifically, as shown in FIG. 10, a user generates in a file of a storage section a folder for each performer and a folder of an album name in a tree structure. The user records the ID tag information including title names, performer names, album names in the generated folders. When the user select piece of music, the audio apparatus displays the tree structure described above, and allows the user to select desired music from among the folders of performer names and the folders of album names.

### SUMMARY OF THE INVENTION

As described above, in a case where a large number of pieces of music are recorded in a music reproduction apparatus and a user selects desired music from the large number of pieces of recorded music, an apparatus with high display property such as a music reproduction apparatus using a personal computer displays the tree structure as described above or display a list of plural titles of music to allow a user to select a desired music easily. However, an in-vehicle audio apparatus and a mobile audio apparatus has a small display section and displays only a title of music under selection or reproduction at best. In order for a user to select desired music, a troublesome searching operation is required. Specifically, in order to select desired music, a user must hear pieces of music step by step from music being reproduced or a folder being reproduced by means of track UP/DOWN or folder UP/DOWN or switching display of information of files and folders.

In view of the problem described above, the invention has been made and provides an information reproduction apparatus capable of recording desired information with attaching a mark such as an ID tag thereto and reading desired information immediately at any time.

According to one embodiment of the invention, an information reproduction apparatus includes a button, a memory, a detection section, a reproduction section, and a control section. The memory has a storage region corresponding to the button. The detection section detects which way the button is pressed in, from among predetermined ways including a first way and a second way. The reproduction section reproduces information stored in a storage section. When the button is pressed while the reproduction section reproduces the information and the detection section detects that the button is pressed in the first way, the control section store subinformation of the information being reproduced in the storage region corresponding to the pressed button. When the button is pressed and the detection section detects that the button is pressed in the second way, the control section reads out subinformation stored in the storage region corresponding to the pressed button. When the control section reads out the subinformation, the reproduction section reproduces information that is stored in the storage section and relates to the read-out subinformation.

According to one embodiment of the invention, an information reproduction apparatus includes a button, a memory, a detection section, a reproduction section, and a control section. The memory has a storage region corresponding to the button. The detection section detects which way the button is pressed in, from among predetermined ways including a first way and a second way. The reproduction section reproduces information stored in a storage section. When the button is pressed after a user temporarily selects at least one piece of subinformation from among subinformation of the information stored in the storage section and the detection section detects that the button is pressed in the first way, the control section stores the subinformation temporarily selected in the storage region corresponding to the pressed button. When the button is pressed and the detection section detects that the button is pressed in the second way, the control section reads out the subinformation stored in the storage region corresponding to the pressed button. When the control section reads out the subinformation, the reproduction section reproduces information that is stored in the storage section and relates to the read-out subinformation.

According to one embodiment of the invention, an information reproduction apparatus includes a reproduction section, a voice recognition section, a memory, and a control section. The reproduction section reproduces information stored in a storage section. Voice is input into the voice recognition section. The memory has a storage region. When the voice recognition section recognizes the input voice as a first voice pattern while the reproduction section reproduces the information stored in the storage section, the control section stores subinformation of the information being reproduced in the storage region. When the voice recognition section recognizes the input voice as a second voice pattern, the control section reads out subinformation stored in the storage region and the reproduction section reproduces information that is stored in the storage section and relates to the read-out subinformation.

According to one embodiment of the invention, an information reproduction apparatus includes a reproduction section, a voice recognition section, a memory, and a control section. The reproduction section reproduces information stored in a storage section. Voice is input into the voice recognition section. The memory has a storage region. When the voice recognition section recognizes the input voice as a first voice pattern after a user temporarily selects at least one piece of subinformation from among subinformation of the information stored in the storage section, the control section stores the subinformation temporarily selected in the storage region. When the voice recognition section recognizes the input voice as a second voice pattern, the control section reads out the subinformation stored in the storage region and the reproduction section reproduces information that is stored in the storage section and relates to the read-out subinformation.

According to one embodiment of the invention, a network communication apparatus includes a button, a memory, a detection section, a communication section, and a control section. The memory has a storage region corresponding to the button. The detection section detects which way the button is pressed in, from among predetermined ways including a first way and a second way. When the button is pressed while the communication section connects to a server through a network and the detection section detects that the button is pressed in the first way, the control section stores address of the connected server in the storage region corresponding to the pressed button. When the button is pressed and the detection section detects that the button is pressed in the second way, the control section reads out address stored in the storage region corresponding to the pressed button and the communication section connects to a server having the read-out address.

According to one embodiment of the invention, a network communication apparatus includes a button, a memory, a detection section, a communication section, and a control section. The memory has a storage region corresponding to the button. The detection section detects which way the button is pressed in, from among predetermined ways including a first way and a second way. When the button is pressed after a user temporarily selects at least one address and the detection section detects that the button is pressed in the first way, the control section stores the address temporarily selected in the storage region corresponding to the pressed button. When the button is pressed and the detection section detects that the button is pressed in the second way, the control section reads out address stored in the storage region corresponding to the pressed button and the communication section connects to a server having the read-out address.

According to one embodiment of the invention, a network communication apparatus, includes a communication section, a voice recognition section, a memory, and a control section. Voice is input into the voice recognition section. The memory has a storage region. When the voice recognition section recognizes the input voice as a first voice pattern while the communication section connects to a server, the control section stores address of the connected server in the storage region. When the voice recognition section recognizes the input voice as a second voice pattern, the control section reads out address stored in the storage region and the communication section connects to a server having the read-out address.

According to one embodiment of the invention, a network communication apparatus includes a communication section, a voice recognition section, a memory, and a control section. Voice is input into the voice recognition section. The memory has a storage region. When the voice recognition section recognizes the input voice as a first voice pattern after a user temporarily selects at least one address, the control section stores the temporarily selected address in the storage region. When the voice recognition section recognizes the input voice as a second voice pattern, the control section reads out address stored in the storage region and the communication section connects to a server having the read-out address.

According to one embodiment of the invention, a voice record and reproduction apparatus includes a button, a memory, a detection section, a reproduction section, a microphone, and a control section. The memory has a storage region corresponding to the button. The detection section detects which way the button is pressed in, from among predetermined ways including a first way and a second way. The reproduction section reproduces voice stored in the memory. When the detection section detects that the button is pressed in the first way, the control section store voice input through the microphone in the storage region corresponding to the pressed button. When the detection section detects that the button is pressed in the second way, the control section reads out the voice stored in the storage region corresponding to the pressed button and the reproduction section reproduces the read-out voice.

According to one embodiment of the invention, a voice record and reproduction apparatus includes a microphone, a voice recognition section, a memory, a reproduction section, and a control section. The microphone receives voice. The voice recognition section processes the received voice. The memory has a storage region. The reproduction section reproduces voice stored in the memory. When the voice recognition section recognizes the received voice as a first voice pattern, the control section stores the voice received by the microphone in the storage region after the recognition by the voice recognition section. When the voice recognition section recognizes the input voice as a second voice pattern, the control section reads out the voice stored in the storage region and the reproduction section reproduces the read-out voice.

### BRIEF DESCRIPTION OF THE DRAWINGS

FIG. 1 is a view showing an information reproduction apparatus according to an embodiment of the invention.

FIG. 2 is a flowchart showing the operation of the information reproduction apparatus according to the embodiment of the invention.

FIG. 3 is a flowchart showing another operation of the information reproduction apparatus according to the embodiment of the invention.

FIG. 4 is a view showing an operation panel of an in-vehicle music player to which the information reproduction apparatus according to the embodiment of the invention is applied.

FIG. 5 is a schematic block diagram of the in-vehicle music player shown in FIG. 4.

FIG. 6 is a flowchart showing an operation of the in-vehicle music player shown in FIG. 5.

FIG. 7 is a view showing an information reproduction apparatus according to another embodiment of the invention.

FIG. 8 is a view showing a voice record and reproduction apparatus to which the information reproduction apparatus according to the embodiment of the invention is applied.

FIG. 9 is a flowchart showing an operation of the voice record and reproduction apparatus shown in FIG. 8.

FIG. 10 is a view showing the tree structure of files in a music storage device.

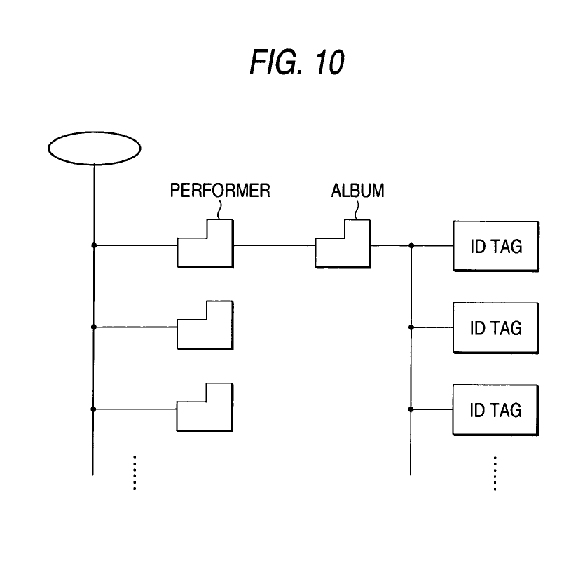

FIGS. 11A to 11D show storage states of a storage region.

FIG. 12 shows a schematic diagram of ID tag according to ID3v2.

FIGS. 13A to 13C show display examples on a display unit 11 of an in-vehicle music player according to an embodiment of the invention.

### DETAILED DESCRIPTION OF THE PREFERRED EMBODIMENTS

### Embodiment 1

Now referring to the drawings, an explanation will be given of various embodiments of the invention.

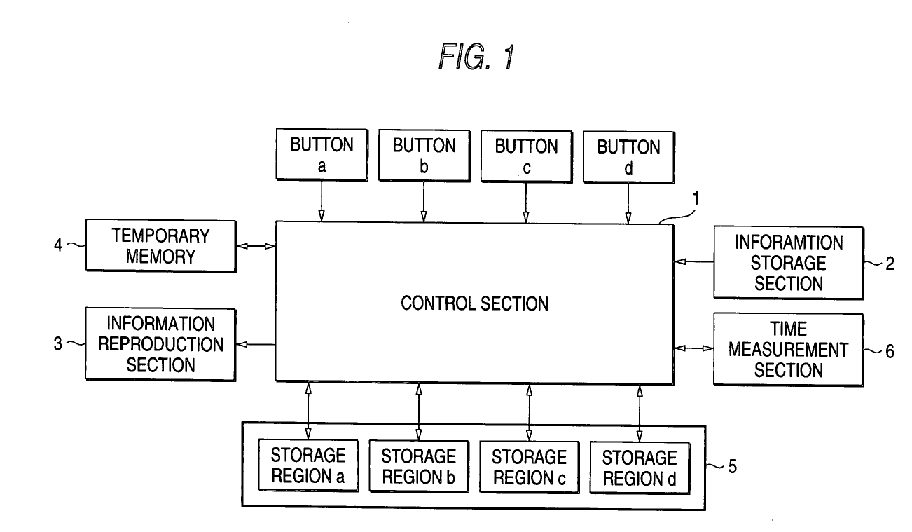

FIG. 1 is a view showing a configuration of an information reproduction apparatus, e.g. a compressed-motion-picture reproduction apparatus according to an embodiment of the invention. The information reproduction apparatus has a control section 1, an information storage section 2, an information reproduction section 3, a temporary memory 4, a memory 5, a time measurement section 6 and operation buttons a to d. The memory 5 has storage regions a to d corresponding to the operation buttons a to d, respectively.

The control section 1 controls the respective sections of the information reproduction apparatus. The information storage section 2 may be a CD, MD or HDD, which stores information such as compressed motion picture. The information reproduction section 3 may be a motion-picture reproduction apparatus, which reproduces the information stored in the information storage section 2. The temporary memory 4 stores subinformation relating to information being reproduced by the information reproduction section 3. Examples of the subinformation include ID tag information for MP3 such as ID3v1 and ID3v2, and file information of compressed motion picture. Here, the file information may include a file name, file size, file type, created date and time, updated date and time, and/or accessed date and time. The operation buttons a to d may be hardware buttons, or in a case where a display equipped with a touch panel is used, may be operation buttons displayed on the touch panel. When one of the operation buttons a to d is pressed, the time measurement section 6 measures time period during which the operation button is pressed.

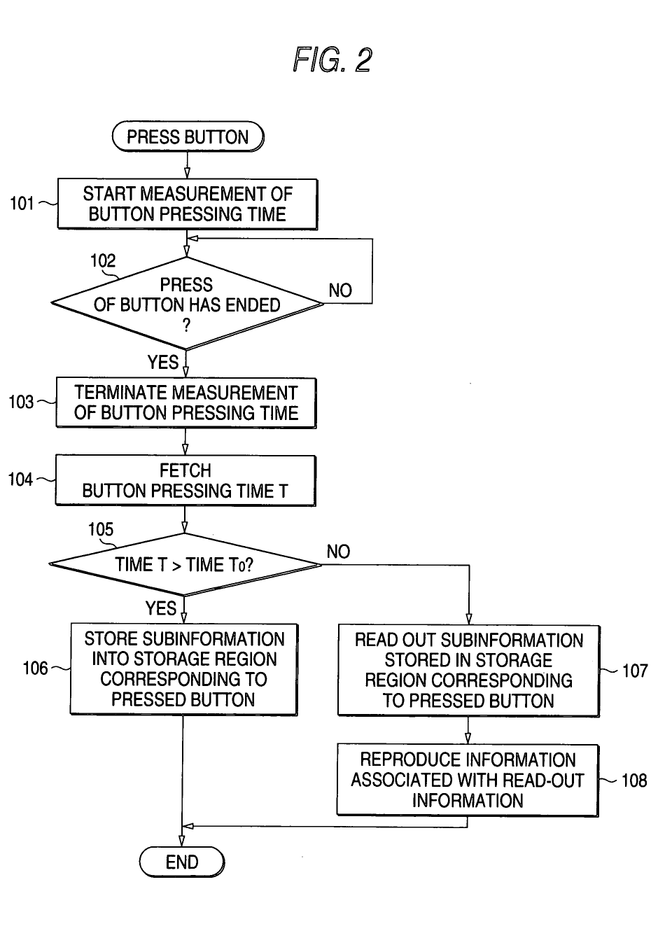

Now referring to the flowchart of FIG. 2, an explanation will be given of operation of the information, reproduction apparatus shown in FIG. 1.

When anyone of the operation buttons a to d, e.g. operation button b, is pressed while the information reproduction section 3 reproduces information, e.g. motion picture, stored in the information storage section 2, the control section 1 starts a program shown in the flowchart of FIG. 2. First, the control section 1 instructs the time measurement section 6 to start the time measurement (step 101). Next, the control section 1 determines whether or not the press of the operation button b has ended (step 102). If the control section 1 concludes that the press of the operation button b has ended, the control section 1 instructs the time measurement section 6 to terminate the time measurement (step 103) and thereafter fetches time T measured by the time measurement section 6 (step 104).

Next, the control section 1 determines whether or not the time T thus fetched is longer than a predetermined time T₀ (step 105). If the time T is longer than the predetermined time T₀, the control section 1 stores subinformation of the information being reproduced at this time, e.g. file information of compressed motion picture, which is stored in the temporary memory 4, into the storage region b (step 106). Then, the control section 1 terminates the program. If the information reproduction section 3 reproduces no information at a time of step 106, the control section 1 may store no subinformation into the storage region corresponding to the pressed operation button.

On the other hand, in step 105, if the control section 1 concludes that the time T is shorter than the predetermined time T₀, the control section 1 reads out subinformation, e.g. file information of the compressed motion picture, stored in the storage region b (step 107). Next, the control section 1 reads out compressed motion picture associated with the read-out subinformation from the information storage section 2, and reproduces it through the information reproduction section 3 (step 108).

In this way, when a user wants to reproduce information being reproduced again later during reproduction of the information, the user can store subinformation of the information being reproduced into one of the storage regions a to d corresponding to the operation buttons a to d by long-pressing one of the operation buttons a to d (that is, pressing one of the operation buttons a to d for time longer than the predetermined time T₀). Therefore, the user can reproduce desired information at any time by short-pressing one of the operation buttons a to d (that is, pressing for time shorter than the predetermined time T₀).

When a user temporarily selects at lease one piece of information from among the information stored in the information storage section 2 and long-presses one of the operations buttons a to d, the control section 1 may store subinformation of the temporarily selected information into the storage region a to d corresponding to the pressed operation button. An example of the “temporal selection” is that a user selects at least one piece of music from a music list displayed on a display, but has not instructed to reproduce the selected piece of music.

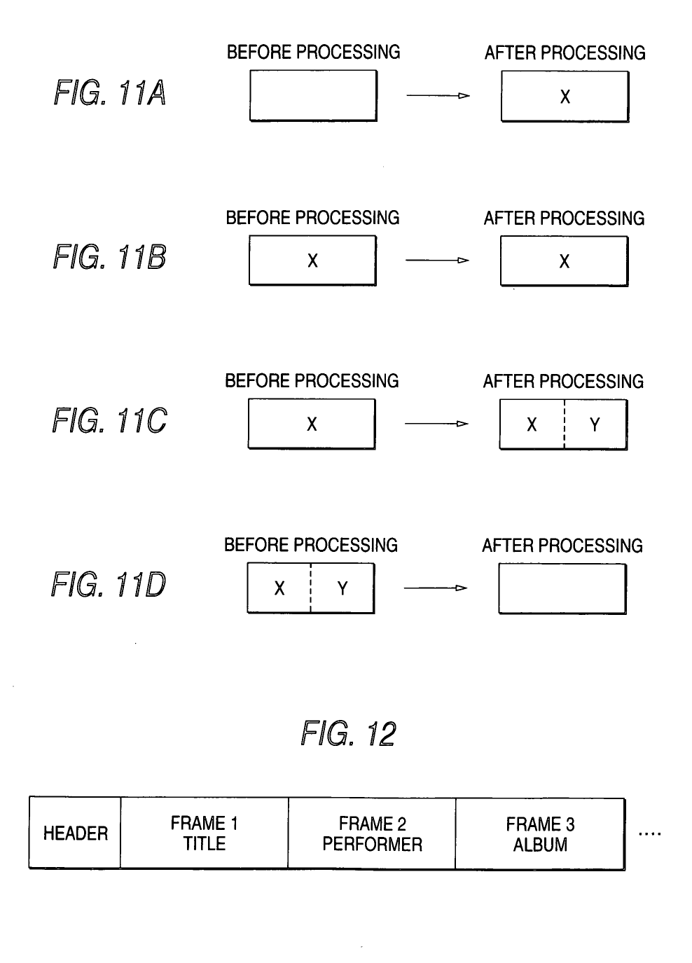

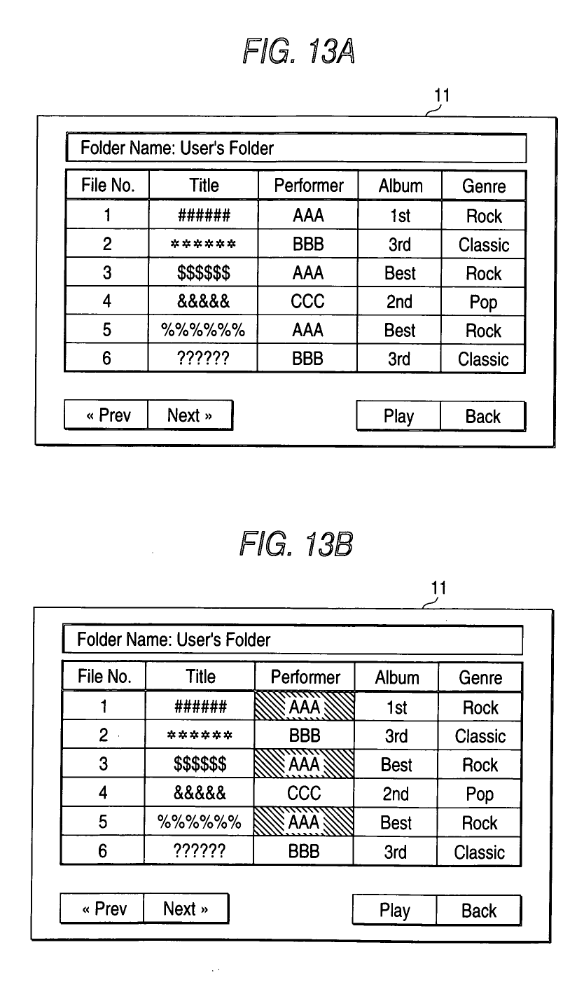

FIGS. 11A to 11D show storage states of a storage region. When the control section 1 is to store subinformation X into the storage region, the storage region holds the subinformation Xafter the processing as shown in FIG. 1A. Here, it is assumed that the subinformation is an ID tag (ID3v2). FIG. 12 shows a schematic diagram of an ID tag according to ID3v2. The ID tag according to ID3v2 has a header and at least one frame having text data. For example, frames 1 to 3 have text data indicating a title of music, a performer name, and a title of album, respectively. If a user short-presses an operation button corresponding to the storage region shown in FIG. 11A (in the after-processing state), the control section 1 instructs the information reproduction section 3 to reproduce information (music) that is stored in the information storage section 2 and is associated with the ID tag (subinformation) X.

Manufacturer or a user may input reproduction setting information indicating one of frame types into the memory 5 in advance. It is assumed that the reproduction setting information indicates a “performer name” and the frame 2 (performer name) of the ID tag X indicates a performer A. In this case, if a user short-presses an operation button corresponding to the storage region shown in FIG. 11A, the control section 1 may instruct the information reproduction section 3 to reproduce music played by the performer A from among pieces of music stored in the information storage section 2. In other words, when a user short-presses an operation button, the control section 1 may automatically search for music, which is stored in the information storage section 2 and is associated with an ID tag having the same text data in the frame type indicated by the reproduction setting information as the ID tag stored in the storage region corresponding to the short-pressed operation button. Then, the control section 1 instructs the information reproduction section 3 to reproduce music according to the search result.

If the storage region has already stored the ID tag X and the control section 1 is to store another ID tag Y into the storage region, the control section 1 may delete the ID tag X and then store the ID tag Y into the storage region as shown in FIG. 11B. Alternatively, the control section 1 may add the ID tag Y, that is, the storage region may hold the two ID tags X and Y as shown in FIG. 1C. When a user short-presses an operation button corresponding to the storage region shown in FIG. 1C, the control section 1 instructs the information reproduction section 3 to reproduce information (music) associated with the ID tag X and information (music) associated with the ID tag Y subsequently. Of course, in this case, the control section 1 may perform the automatic search as described above.

It is assumed that the information reproduction apparatus further has a delete button. When a user presses an operation button and the delete button simultaneously, the control section 1 may delete all ID tags stored in a storage region corresponding to the pressed operation button as shown in FIG. 11D. Instead of providing the delete button, the deleting of ID tags stored in a storage region may be implemented by operating the operation button such as double click, other than the long-press and the short-press.

Also, if a user performs the delete operation as described above while information is being reproduced, the control section 1 may delete only ID tag of the information being reproduced from among ID tags stored in the storage regions.

In the embodiment described above, if the operation button is long-pressed, the control section 1 stores subinformation of information being reproduced into the corresponding storage region. However, for example, since a motion-picture reproduction apparatus or a music reproduction apparatus displays on the display a reproduction position as an elapsed time, the information reproduction apparatus may store a reproduction position of information being reproduced into a storage region. With this configuration, it is possible to reproduce the information from the reproduction position stored in the storage region.

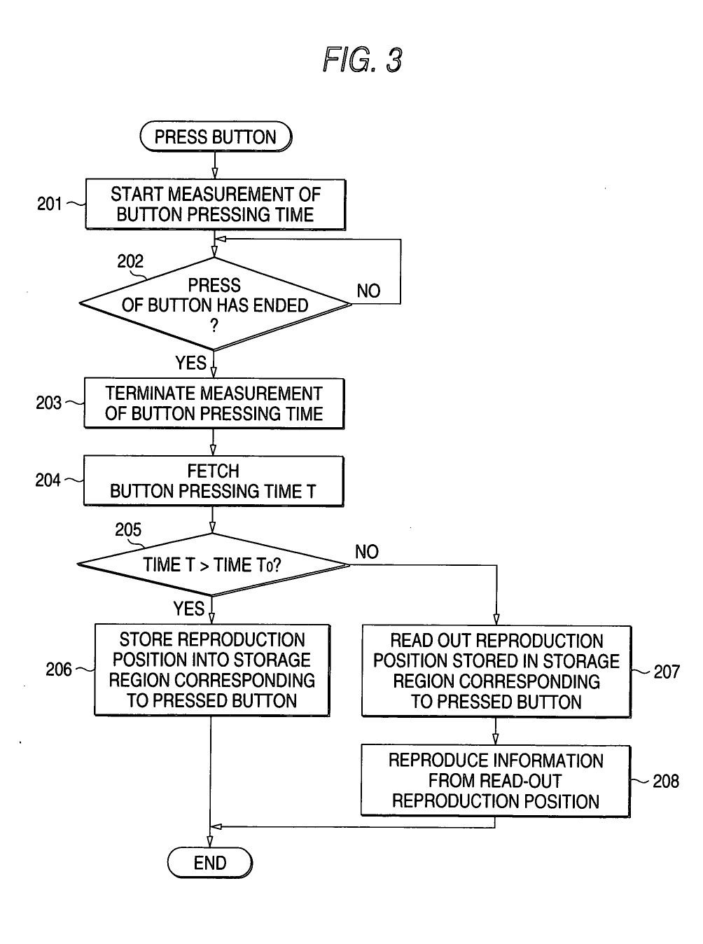

With reference to the block diagram of FIG. 1 and flowchart of FIG. 3, an explanation will be given of an embodiment in which the control section 1 stores a reproducing position of information into a storage region corresponding to a pressed operation button. Incidentally, in this embodiment, the temporal memory of FIG. 1 sequentially stores a reproducing position of information being reproduced at that time.

As in the embodiment describe above, when any one of the operation buttons a to d, e.g. operation button c is depressed while the information reproduction section 3 reproduces information, the control section 1 starts a program shown in the flowchart of FIG. 3. First the control section 1 instructs the time measurement section 6 to start the time measurement (step 201). Next, the control section 1 determines whether or not the press of the operation button c has ended (step 202). If the control section 1 concludes that the press of the operation button c has ended, the control section 1 instructs the time measurement section 6 to terminate the time measurement (step 203) and thereafter fetches time T measured by the time measurement section 6 (step 204).

Next, the control section 1 determines whether or not the time T thus fetched is longer than a predetermined time T₀ (step 205). If the time T is longer than the predetermined time T₀, the control section 1 stores a reproducing position of the information being reproduced, which is stored in the temporary memory 4, into the storage region c (step 206). Then, the control section 1 terminates the program.

On the other hand, in step 205, if the control section 1 concludes that the time T is shorter than the predetermined time T₀, the control section 1 reads out a reproducing position stored in the storage region c (step 207). Next, the control section 1 reads out information subsequent to the read-out reproducing position from the information storage section 2, and reproduces it through the information reproduction section 3 (step 208).

In this way, when a user wants to reproduce information being reproduced again later from a specific reproduction position, the user can store a reproduction position, at that time, of information being reproduced into one of the storage regions a to d corresponding to the operation buttons a to d will be reproduced from a specific reproducing position by long-pressing one of the operation buttons a to d. Therefore, the user can reproduce information from a desired reproduction position at any time by short-pressing one of the operation buttons a to d.

Incidentally, in this embodiment, the control section 1 stores a reproducing position in a storage region corresponding to a pressed operation button, as a starting position of the information reproduction. However, in a case where the same operation button is long-pressed twice, the former long-press and the latter long-press may cause the control section 1 to store a starting position and an ending position into the corresponding storage region, respectively. In this case, if a user short-presses the operation button, the control section 1 instructs the information reproduction section 3 to reproduce a part of information between the stored starting position and the stored ending position. Further, a starting position and an ending position of information reproduction may be stored into storage regions corresponding to two operation buttons. In this case, during the information reproduction, a part of information between the stored starting position and the stored ending position may be reproduced.

### Embodiment 2

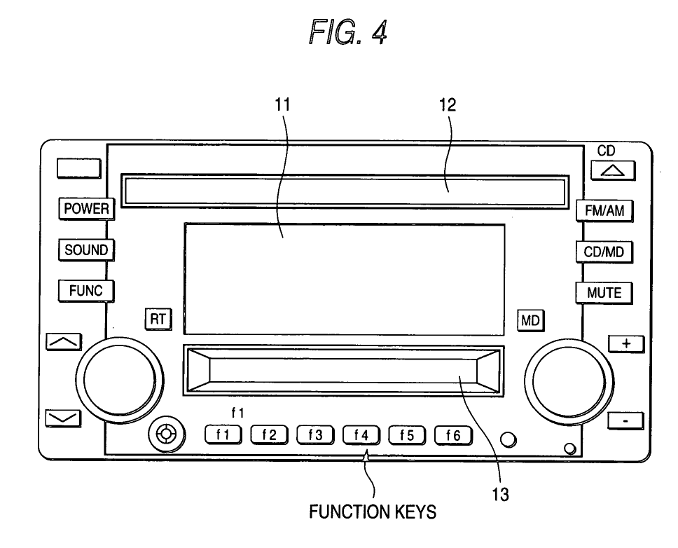

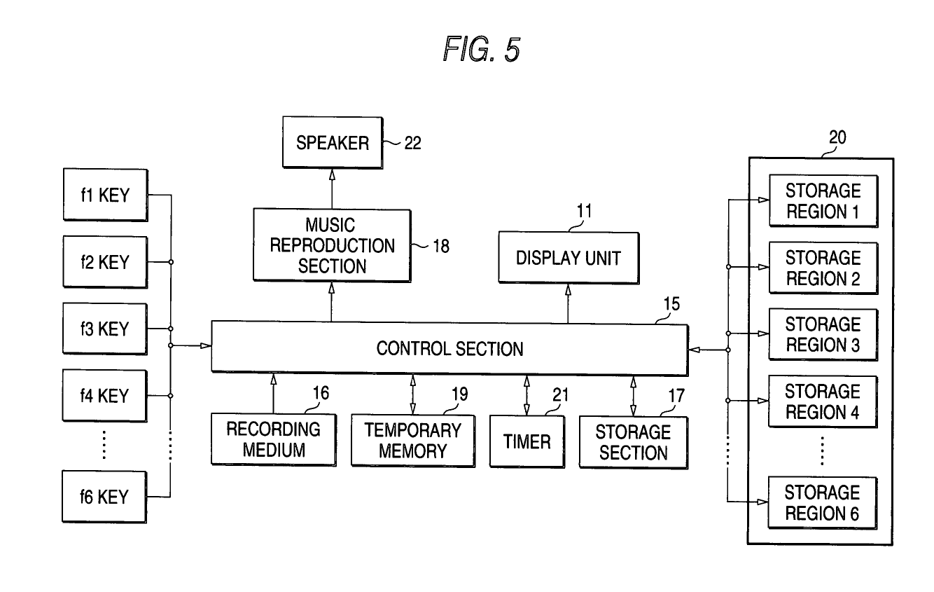

Now referring to FIGS. 4 and 5, an explanation will be given of an in-vehicle music player to which an information reproduction apparatus according to an embodiment of the invention is applied.

FIG. 4 is a view showing an operation panel of the in-vehicle music player. At the center of the operation panel, a display unit 11 is provided. On the upper side of the display unit 11, a CD inserting slot 12 from which a CD is inserted is provided. On the lower side of the display unit 11, an MD inserting slot 13 from which an MD is inserted is provided. On the left and right sides of the display unit 11, various operation buttons are arranged. On the bottom side of the operation panel, six function keys f1 to f6 are arranged. On the panel of the display unit 11, touch panel switches are arranged. A user presses a button displayed on the display unit 11 to select an ID tag (subinformation) corresponding to the pressed button or execute function corresponding to the pressed button.

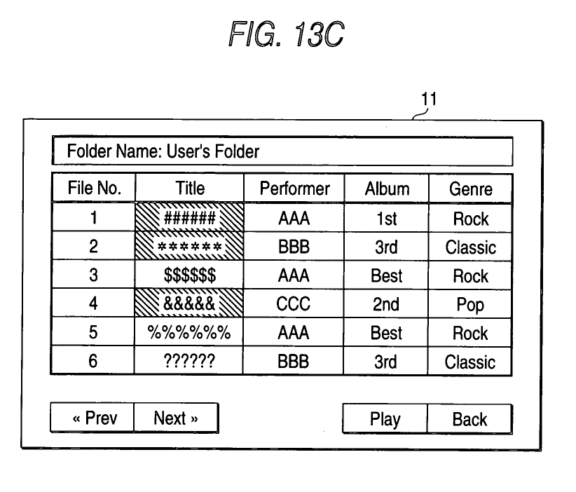

Upon receiving an instruction from a user, the in-vehicle music player displays folder information and ID tags (such as performer name and title of music) of pieces of music on the display unit 11 as shown in FIG. 13A. When the user selects one of the titles of music and presses a “play” button, the in-vehicle music player reproduces the selected music. On the other hand, in the state of FIG. 13A, the user is allowed to select ID tag, e.g. performer name, other than the title of music as shown in FIG. 13B or select plural ID tags as shown in FIG. 13C. In FIG. 13B, the performername “AAA” selected. In FIG. 13C, three pieces of music (file numbers 1, 2, and 4) are selected. In other words, FIGS. 13B and 13C show examples of “user's temporal selection”. When the user presses the “play” button after the “user's temporal selection”, the in-vehicle music player plays music corresponding to the temporally selected ID tags in order.

FIG. 5 is a schematic block diagram of the in-vehicle music player. As shown in FIG. 5, the in-vehicle music player has a control section 15, a recording medium 16 such as a CD or an MD, a storage section 17 such as a hard disk drive (HDD), a music reproduction section 18 such as a CD player or an MP3 player, a temporary memory 19, a memory 20, a timer 20 and a speaker 22. The memory 20 has storage regions 1 to 6 corresponding to the function keys f1 to f6.

The control section 15 controls the respective sections constituting the in-vehicle music player. The storage section 17 can store a larger number of pieces of copied music equivalent to a large number of recording media such as the CD. Therefore, a user can select desired music and instruct the in-vehicle music player to play (reproduce) the selected music through the music player 18. The temporary memory 19 temporarily stores an ID tag of music being played during music reproduction. Also, the temporary memory 19 temporarily stores folder information of music being selected and/or an ID tag of music being selected during music selection. An ID tag may include frames of “title of music”, “performer name”, “title of album”, “genre”, “lyricist name”, “composer name”, and “dominical-year”.

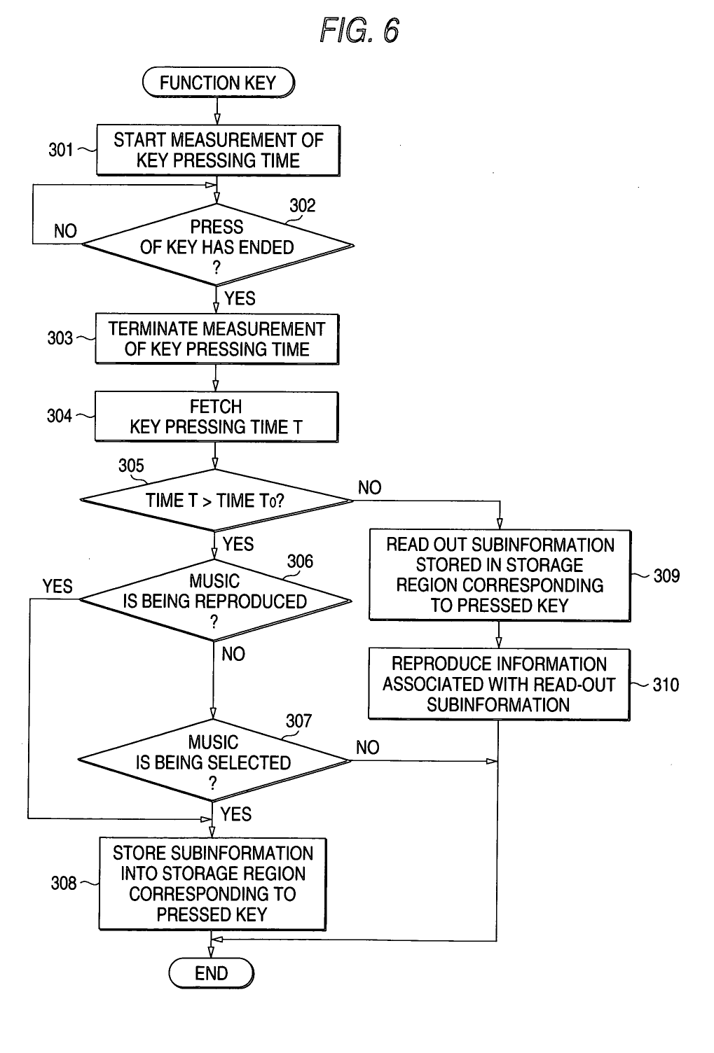

Referring to the flowchart of FIG. 6, an explanation will be given of the operation of the music player shown in FIG. 5. Incidentally, it is assumed that the music player is now set in a state where pieces of music stored in the storage section 17 such as the HDD can be played.

When any one of the function keys f1 to f6, e.g. f4 key is pressed, the control section 15 starts a program shown in the flowchart of FIG. 6 to instruct the timer 21 to start measuring key pressing time (step 301). Next, the control section 15 determines whether or not the press of the function key f4 has ended (step 302). If the control section 15 concludes that the press of the function key f4 has ended, the control section 15 instructs the timer 21 to terminate the time measurement (step 303) and thereafter fetches time T measured by the timer 21 (step 304).

Next, the control section 15 determines whether or not the time T thus fetched is longer than a predetermined time To (step 305). If the time T is longer than the predetermined time To, the control section 15 determines whether or not music is being played (reproduced) currently (step 306). If the control section 15 concludes that music is being played, the control section 15 stores an ID tag of the music being played, which is stored in the temporary memory 4, into the storage region 4 (step 308). Then, the control section 15 terminates the program. In a case where the memory 20 stores reproduction setting information indicating one of frame types, the control section 15 may store only a frame of an ID tag of the music being played, which is indicated by the reproduction setting information, into the storage region 4, instead of storing the entire ID tag.

Further, if the control section 15 concludes that music is not being played, the control section 15 determines whether or not a user is selecting any music currently (step 307). If a user is selecting any music, the control section 15 stores the folder information and/or the ID tag, which is stored in the temporary memory 4, into the storage region 4 (step 308). If a user is not selecting music, the control section 15 terminates the program. Alternatively, when a user has temporarily selected at least one of frames of an ID tag, e.g., when a user has temporarily selected a performer A as shown in FIG. 13B, the control section 15 may store only the selected frame (e.g. the performer A) into the storage region 4.

On the other hand, in step 305, if the control section 15 concludes that the time T is shorter than the predetermined time To, the control section 15 reads out the folder information and/or the ID tag stored in the storage region 4 (step 309). Next, the control section 15 reads outmusic, which is associated with the thus read ID tag, from the storage section 17, and plays it through the music reproduction section 18 (step 310). Thus, desired music will come from the speaker so that a user can enjoy the desired music.

As described above, when the storage region 4 stores an ID tag and a user short-presses the function key f4, music associated with the stored ID tag is reproduced. When the storage region 4 stores folder information and a user short-presses the function key f4, music stored in a folder indicated by the folder information is reproduced subsequently.

Also, the memory 20 may store reproduction setting information indicating one of frame types in advance. It is assumed that the reproduction setting information stored in the memory 20 indicates the “performer name”. In this case, when a user short-presses the function key f4, the control section 15 may automatically search for music, which is stored in the recording medium 16 and is associated with an ID tag having the same performer name in the “performer name” frame as the ID tag stored in the storage region 4. Then, the control section 15 instructs the music reproduction section 18 to play music according to the search result. Of course, the frame type indicated by the reproduction setting information is not limited to the “performer name”, but may be “title of music”, “title of album”, “genre”, “lyricist name”, “composer name”, “dominical-year”, or the like. In any case, the control section 15 may perform the automatic search and instruct the music reproduction section 18 to play music according to the search result.

In a case where the control section 15 stores only a frame temporarily selected by a user into a storage region, the step 309 may be modified as below. That is, the control section 15 reads out a frame stored in a storage region corresponding to a pressed operation button. Then, the control section 15 searches the storage section 17 for an ID tag having the same data in a frame type to which the read-out frame belongs as the read-out frame. After the control section 15 executes the searching, the music reproduction section 18 subsequently plays music that is stored in the storage section 17 and is associated with the retrieved ID tag. For example, when the storage region 4 has stored a frame indicating “performer A” and a user short-presses the function key f4, the control section 15 reads out the frame indicating “performer A” from the storage region 4. Then, the control section 15 searches the storage section 17 for an ID tag having “performer A” in the performer frame. After the search, themusic reproduction section 18 subsequently plays music, which is stored in the storage section 17 and is played by the “performer A”.

Incidentally, when a user long-presses a function key, which corresponds to a storage region in which an ID tag of music has already been stored, the control section 15 may delete the stored ID tag and then stores another ID tag of music, which is being played or selected, into the storage region (see FIG. 11B). Alternatively, when a user long-presses a function button, which corresponds to a storage region in which an ID tag of music has already been stored, the control section 15 may add another ID tag of music, which is being played or selected, to the storage region (see FIG. 11C).

### Embodiment 3

In the embodiments described above, a user uses an operation button to store subinformation (e.g. an ID tag) of information (e.g. music) to be reproduced, into a storage region corresponding to the operation button. However, this embodiment employs a voice recognition apparatus in place of the operation button of the previous embodiment. That is, a user says and inputs particular words through the voice recognition apparatus to store subinformation of information into a storage region.

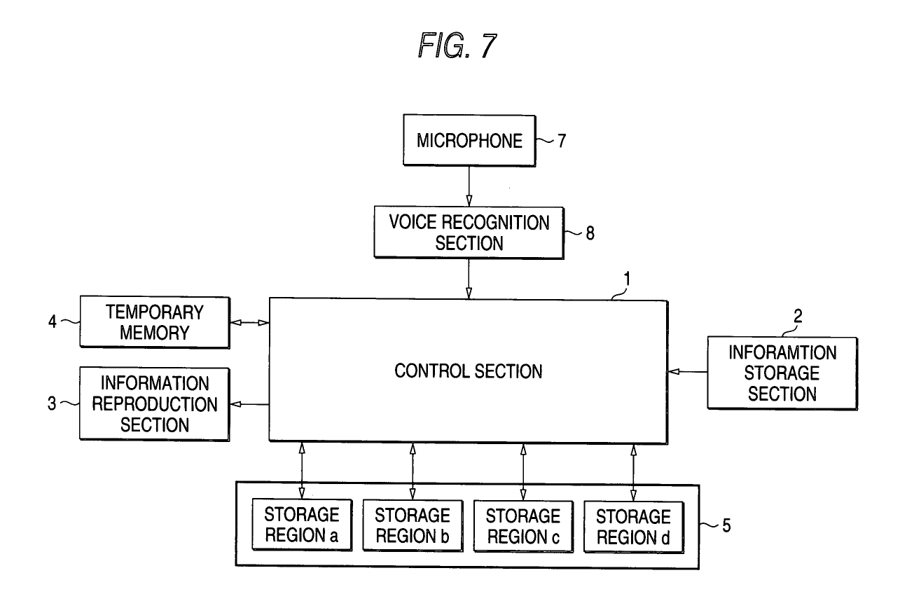

FIG. 7 is a view showing an information reproduction apparatus according to this embodiment, which stores subinformation of information into a storage region through voice recognition. As shown in FIG. 7, the information reproduction apparatus has a control section 1, an information storage section 2, an information reproduction section 3, a temporary memory 4, a memory 5, a microphone 7 and a voice recognition section 8. The memory 5 has storage regions a to d for storing subinformation of information.

An explanation will be given of operation of the information reproduction apparatus shown in FIG. 7.

When a user successively says voice “memory a” and voice “save” while information is being reproduced or selected, these voices are supplied to the voice recognition section 8 through the microphone 7, and then the voice recognition section 8 performs voice analysis and inputs voice information thus obtained to the control section 1. The control section 1 compares stored keywords with the voice information, thereby recognizing “storage region a” and “storing subinformation”. Then, the control section 1 stores subinformation (e.g., ID tag) stored in the temporary memory 4, into the storage region a. The temporary memory 4 temporarily stores subinformation of information (e.g., music), which is being reproduced or selected.

On the other hand, when a user successively says voice “memory a” and voice “load”, these voices are supplied to the voice recognition section 8 through the microphone 7, and then the voice recognition section 8 performs voice analysis and inputs voice information thus obtained to the control section 1. On the basis of this voice information, the control section 1 reads out subinformation stored in the storage region a. The control section 1 further reads out information, which is associated with the thus read subinformation, and reproduces the read information through the information reproduction section 3.

In this way, by means of the voice recognition apparatus, it is possible to-store subinformation of information, which is being reproduced or selected, into a storage region or to reproduce information without providing an operation button. Further, this embodiment allows a user to store subinformation of information or to reproduce desired information more easyily.

In the embodiments described above, the explanation has been given of the examples in which the information reproduction apparatus is applied to the music player or the compressed-motion-picture reproduction apparatus. However, the information reproduction apparatus according to embodiments of the invention may also be applied to a voice record and reproduction apparatus.

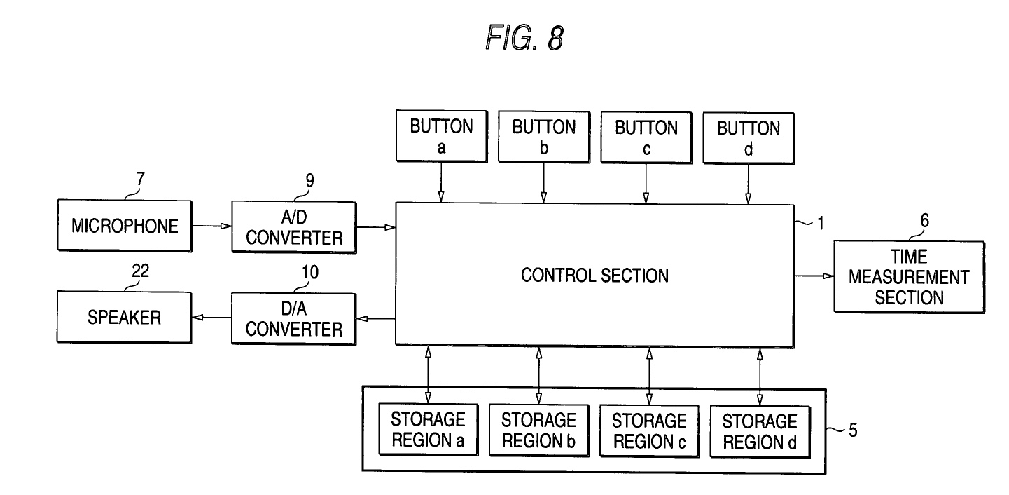

FIG. 8 is a view showing a voice record and reproduction apparatus to which the information reproduction apparatus according to the embodiments of the invention is applied. This voice record and reproduction apparatus has a control section 1, a memory 5, a time measurement section 6, a microphone 7, an A/D converter 9, a D/A converter 10, a speaker 22 and operation buttons a to d. The memory 5 has storage regions a to d corresponding to the operation buttons a to d.

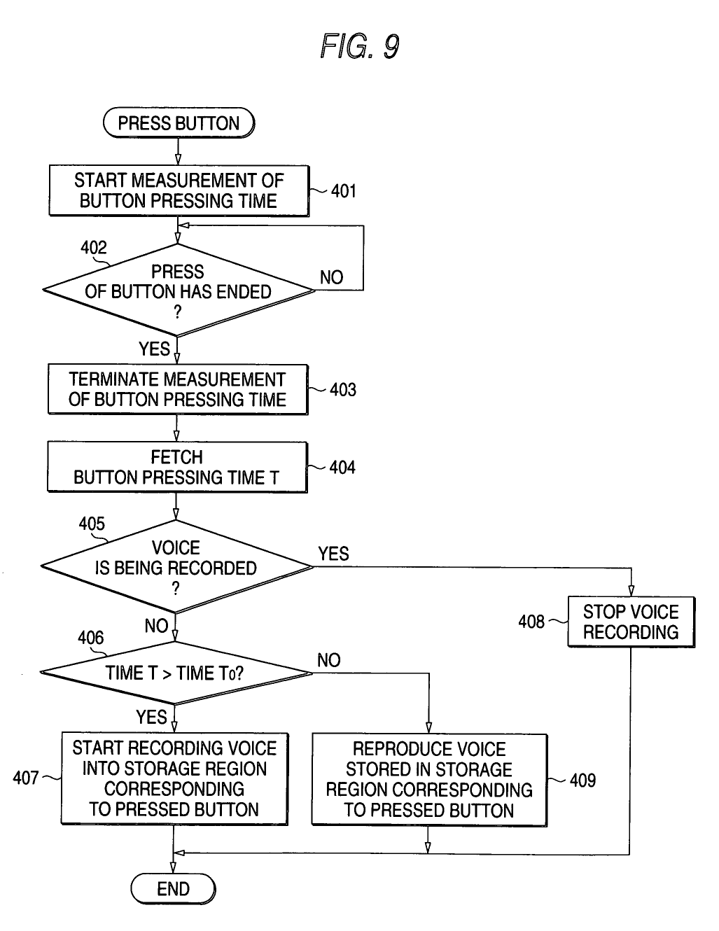

Now referring to the flowchart of FIG. 9, an explanation will be given of operation of the voice record and reproduction apparatus shown in FIG. 8.

When any one of the operation buttons a to d, e.g. an operation button d, is pressed, the control section 1 starts a program shown in the flowchart of FIG. 9 to instruct the time measurement section 6 to start the time measurement (step 401). Next, the control section 1 determines whether or not press of the operation button d has ended (step 402). If the control section 1 concludes that the press of the operation button b has ended, the control section 1 instructs the time measurement section 6 to terminate the time measurement (step 403) and thereafter fetches time T measured by the time measurement section 6 (step 404).

Next, the control section 1 determines whether or not voice is being recorded at present (step 405). If the control section 1 concludes that voice is not being recorded, the control section 1 determines whether or not the time T thus fetched is longer than a predetermined time T₀ (step 406). If the time T is longer than the predetermined time T₀, the control section 1 starts voice recording to record voice supplied through the A/D converter 9 from the microphone 7 in the storage region d corresponding to the operation button d (step 407). Further, in step 405, if the control section 1 concludes that voice is being recorded, the control section 1 stops the voice recording into the storage region d (step 408).

On the other hand, in step 406, if it is determined that the time T is shorter than the predetermined time T₀, the control section 1 reads out voice recorded in the storage region d and supplies the read-out voice to the speaker 22 through the D/A converter 10, thereby reproducing the voice recorded in the storage region d (step 409).

In this way, when a user long-presses any one of the operation buttons a to d, voice is recorded into the storage region a to d corresponding to the pressed operation button a to d. If necessary, when a user short-presses any one of the operation buttons a to d, a desired voice is reproduced. Thus, the embodiment simplifies operations of voice record and voice reproduction. Also, in the case where a large number of pieces of voice information are recorded, the desired voice can be easily selected and reproduced.

In the embodiments described above, when a user long-presses an operation button (that is, a user presses an operation button longer than the predetermined time T₀), subinformation (e.g. an ID tag) of information (e.g. music), a reproduction position, or voice is stored into a storage region corresponding to the pressed operation button. Also, when a user short-presses an operation button (that is, a user presses an operation button shorter than the predetermined time T₀), information (such as music, motion picture, or voice) is reproduced. However, a way of operating an operation button according to the invention is not limited thereto. For example, when a user double-clicks an operation button, information may be stored into a storage region corresponding to the double-clicked operation button; and when a user single-clicks an operation button, information may be read out and reproduced from a storage region corresponding to the single-clicked operation button. Alternatively, when a user short-presses an operation button, information may be stored into a storage region corresponding to the pressed operation button; and when a user long-presses an operation button, information may be read out and reproduced from a storage region corresponding to the pressed operation button.

In the embodiments described above, the temporary memory stores subinformation of information. However, the temporary memory may be omitted so long as the control section reads out subinformation of information, which is being reproduced or selected, or a reproduction position from the information storage section.

Further, the music player according to the embodiment described above plays music stored in the storage section such as HDD. However, an information reproduction apparatus according to the invention may be applied to a music player that plays music recorded in a recording medium such as a CD or an MD.

Further, in the embodiments described above, a music player and a compressed motion picture reproduction apparatus are described as an information reproduction apparatus. An information reproduction apparatus according to the invention may be applied to a digital television. In that case, when a user long-presses an operation button, the digital television stores channel information being selected into a storage region corresponding to the pressed operation button. Also, an information reproduction apparatus according to the invention maybe applied to an internet access device that uses a portable terminal or a in-vehicle terminal. In that case, when a user long-presses an operation button, the internet access device stores URL address into a storage region corresponding to the pressed operation button. With this configuration, when a user short-presses an operation button at any time, a user can watch a program broadcast on a desired channel or browse a homepage at a desired URL address.

In the case where an information reproduction apparatus according to the invention is applied to an internet access device, the internet access device may store an URL address corresponding to a homepage being displayed currently in response to user's operation with respect to an operation button. Also, instead of storing an URL address corresponding to a homepage being displayed currently, the internet access device may store an URL address being selected temporarily. Examples of the URL address being selected temporarily include an URL address, which is just entered in address bar (a home page corresponding to such an URL address has not been read out and displayed).

Further, an information reproduction apparatus according to this invention may be applied to a navigation apparatus or a PDA. In that case, when a user long-presses an operation button, the navigation apparatus or the PDA stores screen being displayed currently into a storage region corresponding to the pressed operation button; and when a user short-presses an operation button, the navigation apparatus or the PDA reads out the stored screen from a storage region corresponding to the pressed operation button. Further, an information reproduction apparatus according to the invention may be applied to a voice communication device through the Internet such as a voice chat or an IP telephone. In that case, when a user long-presses an operation button, the voice communication device stores person at the other end of the line, e.g. telephone number, into a memory corresponding to the pressed operation button; when a user short-presses an operation button, the voice communication device automatically connects the telephone number stored in a memory corresponding to the pressed operation button.

1. An information reproduction apparatus comprising:
a button;
a memory that has a storage region corresponding to the button;
a detection section that detects which way the button is pressed in, from among predetermined ways including a first way and a second way;
a reproduction section that reproduces information stored in a storage section; and
a control section, wherein:
when the button is pressed while the reproduction section reproduces the information and the detection section detects that the button is pressed in the first way, the control section store subinformation of the information being reproduced in the storage region corresponding to the pressed button;
when the button is pressed and the detection section detects that the button is pressed in the second way, the control section reads out subinformation stored in the storage region corresponding to the pressed button; and
when the control section reads out the subinformation, the reproduction section reproduces information that is stored in the storage section and relates to the read-out subinformation.

2. The information reproduction apparatus according to claim 1, wherein:
the memory stores at least one of frame types of subinformation, wherein:
when the button is pressed and the detection section detects that the button is pressed in the second way, the control section reads out the subinformation stored in the storage region corresponding to the pressed button and searches the storage section for subinformation having the same data in the stored frame type; and
after the control section executes the search, the reproduction section subsequently reproduces information that is stored in the storage section and is associated with at least one of the read-out subinformation and the retrieved subinformation.

3. The information reproduction apparatus according to claim 1, wherein:
the first way represents long pressing of the button; and
the second way represents short pressing of the button.

4. The information reproduction apparatus according to claim 1, wherein the information includes music information.

5. The information reproduction apparatus according to claim 1, wherein the information includes one of image information and motion-picture information.

6. The information reproduction apparatus according to claim 5, wherein the subinformation represents file information of compressed video.

7. The information reproduction apparatus according to claim 1, wherein when (a) the button is pressed while the reproduction section reproduces the information stored in the storage section, (b) the corresponding storage region has stored another subinformation, and (c) the detection section detects that the button is pressed in the first way, the control section adds the subinformation of the information being reproduced to the corresponding storage region.

8. The information reproduction apparatus according to claim 1, wherein when (a) the button is pressed while the reproduction section reproduces the information stored in the storage section, (b) the corresponding storage region has stored another subinformation, and (c) the detection section detects that the button is pressed in the first way, the control section deletes the other information from the corresponding storage region and stores the subinformation of the information being reproduced in the corresponding storage region.

9. The information reproduction apparatus according to claim 1, wherein:
the predetermined ways further include a third way; and
when the detection section detects that the button is pressed in the third way and the storage region corresponding to the pressed button has stored subinformation, the control section deletes the stored subinformation from the storage region corresponding to the pressed button.

10. The information reproduction apparatus according to claim 1, wherein:
the predetermined ways further include a third way; and
when (a) the button is pressed while the reproduction section reproduces the information stored in the storage section, (b) the corresponding storage region has stored the subinformation of the information being reproduced, and (c) the detection section detects that the button is pressed in the third way, the control section deletes the subinformation of the information being reproduced from the corresponding storage region.

11. The information reproduction apparatus according to claim 1, wherein the subinformation of the information represents a reproduction position.

12. The information reproduction apparatus according to 11, wherein:
each of the storage region stores at least two reproduction positions;
one of the stored reproduction position represents a reproduction start position; and
the other of the stored reproduction position represents a reproduction end position.

13. The information reproduction apparatus according to claim 1, wherein the subinformation includes at least one of selected from a group consisting of CD-text information, folder information, file information, tag information, album information, performer information, genre information, lyricist information, composer information, and dominical-year information.

14. An information reproduction apparatus comprising:
a button;
a memory that has a storage region corresponding to the button;
a detection section that detects which way the button is pressed in, from among predetermined ways including a first way and a second way;
a reproduction section that reproduces information stored in a storage section; and
a control section, wherein:
when the button is pressed after a user temporarily selects at least one piece of subinformation from among subinformation of the information stored in the storage section and the detection section detects that the button is pressed in the first way, the control section stores the subinformation temporarily selected in the storage region corresponding to the pressed button;
when the button is pressed and the detection section detects that the button is pressed in the second way, the control section reads out the subinformation stored in the storage region corresponding to the pressed button; and
when the control section reads out the subinformation, the reproduction section reproduces information that is stored in the storage section and relates to the read-out subinformation.

15. The information reproduction apparatus according to claim 14., wherein:
when the button is pressed after the user designates at least one of frames of the subinformation to temporarily select the at least one of subinformation from among the subinformation of the information stored in the storage section and the detection section detects that the button is pressed in the first way, the control section stores the at least one of frames as the subinformation temporarily selected into the storage region corresponding to the pressed button;
when the button is pressed and the detection section detects that the button is pressed in the second way, the control section reads out the at least one of frames stored in the storage region corresponding to the pressed button and searches the storage section for subinformation having the same data in a frame type to which the read-out frame belongs as the read-out frame; and
after the control section executes the searching, the reproduction section subsequently reproduces information that is stored in the storage section is associated with the retrieved subinformation.

16. The information reproduction apparatus according to claim 14, wherein when (a) the button is pressed after the user temporarily selects the at least one piece of subinformation, (b) the corresponding storage region has stored another subinformation, and (c) the detection section detects that the button is pressed in the first way, the control section adds the subinformation temporarily selected to the corresponding storage region.

17. The information reproduction apparatus according to claim 14, wherein when (a) the button is pressed after the user temporarily selects the at least one piece of subinformation, (b) the corresponding storage region has stored another subinformation, and (c) the detection section detects that the button is pressed in the first way, the control section deletes the other information from the corresponding storage region and stores the subinformation temporarily selected in the corresponding storage region.

18. The information reproduction apparatus according to claim 14, wherein:
the predetermined ways further include a third way; and
when the detection section detects that the button is pressed in the third way and the storage region corresponding to the pressed button has stored subinformation, the control section deletes the stored subinformation from the storage region corresponding to the pressed button.

19. The information reproduction apparatus according to claim 14, wherein:
the predetermined ways further include a third way; and
when (a) the button is pressed after the user temporarily selects the at least one piece of subinformation, (b) the corresponding storage region has stored the subinformation temporarily selected, and (c) the detection section detects that the button is pressed in the third way, the control section deletes the subinformation temporarily selected from the corresponding storage region.

20. An information reproduction apparatus comprising:
a reproduction section that reproduces information stored in a storage section;
a voice recognition section into which voice is input;
a memory that has a storage region; and
a control section, wherein:
when the voice recognition section recognizes the input voice as a first voice pattern while the reproduction section reproduces the information stored in the storage section, the control section stores subinformation of the information being reproduced in the storage region;
when the voice recognition section recognizes the input voice as a second voice pattern, the control section reads out subinformation stored in the storage region and the reproduction section reproduces information that is stored in the storage section and relates to the read-out subinformation.

21. The information reproduction apparatus according to claim 20, wherein when (a) the voice recognition section recognizes the input voice as the first voice pattern while the reproduction section reproduces the information stored in the storage section and (b) the storage region has stored another subinformation, the control section adds the subinformation of the information being reproduced to the storage region.

22. The information reproduction apparatus according to claim 20, wherein when (a) the voice recognition section recognizes the input voice as the first voice pattern while the reproduction section reproduces the information stored in the storage section and (b) the storage region has stored another subinformation, the control section deletes the other information from the storage region and stores the subinformation of the information being reproduced in the storage region.

23. The information reproduction apparatus according to claim 20, wherein when (a) the voice recognition section recognizes the input voice as a third voice pattern and (b) the storage region has stored subinformation, the control section deletes the stored subinformation from the storage region.

24. The information reproduction apparatus according to claim 20, wherein when (a) the voice recognition section recognizes the input voice as a third voice pattern while the reproduction section reproduces the information stored in the storage section and (b) the storage region has stored the subinformation of the information being reproduced, the control section deletes the subinformation of the information being reproduced from the storage region.

25. The information reproduction apparatus according to claim 20, wherein:
the memory includes a plurality of storage regions;
when the voice recognition section recognizes the input voice as the first voice pattern including (p) indication of one of the storage regions and (q) indication of storing while the reproduction section reproduces the information stored in the storage section, the control section stores subinformation of the information being reproduced in the indicated storage region; and
when the voice recognition section recognizes the input voice as the second voice pattern including (x) indication of one of the storage regions and (y) indication of reading-out, the control section reads out subinformation stored in the indicated storage region.

26. An information reproduction apparatus comprising:
a reproduction section that reproduces information stored in a storage section;
a voice recognition section into which voice is input;
a memory that has a storage region; and
a control section, wherein:
when the voice recognition section recognizes the input voice as a first voice pattern after a user temporarily selects at least one piece of subinformation from among subinformation of the information stored in the storage section, the control section stores the subinformation temporarily selected in the storage region;
when the voice recognition section recognizes the input voice as a second voice pattern, the control section reads out the subinformation stored in the storage region and the reproduction section reproduces information that is stored in the storage section and relates to the read-out subinformation.

27. The information reproduction apparatus according to claim 26, wherein when (a) the voice recognition section recognizes the input voice as the first voice pattern after the user temporarily selects the at least one piece of subinformation and (b) the storage region has stored another subinformation, the control section adds the subinformation temporarily selected to the storage region.

28. The information reproduction apparatus according to claim 26, wherein when (a) the voice recognition section recognizes the input voice as the first voice pattern after the user temporarily selects the at least one piece of information and (b) the storage region has stored another subinformation, the control section deletes the other information from the storage region and stores the subinformation temporarily selected in the storage region.

29. The information reproduction apparatus according to claim 26, wherein when (a) the voice recognition section recognizes the input voice as a third voice pattern and (b) the storage region has stored subinformation, the control section deletes the stored subinformation from the storage region.

30. The information reproduction apparatus according to claim 26 wherein when (a) the voice recognition section recognizes the input voice as a third voice pattern after the user temporarily selects the at least one piece of subinformation and (b) the storage region has stored the subinformation temporarily selected, the control section deletes the subinformation temporarily selected from the storage region

31. The information reproduction apparatus according to claim 26, wherein:
the memory includes a plurality of storage regions;
when the voice recognition section recognizes the input voice as the first voice pattern including (p) indication of one of the storage region and (q) indication of storing after the user temporarily selects the at least one piece of subinformation from among subinformation of the information stored in the storage section, the control section stores the subinformation temporarily selected in the indicated storage region; and
when the voice recognition section recognizes the input voice as the second voice pattern including (x) indication of one of the storage region and (y) indication of reading-out, the control section reads out the subinformation stored in the indicated storage region.

32. A network communication apparatus, comprising:
a button;
a memory that has a storage region corresponding to the button;
a detection section that detects which way the button is pressed in, from among predetermined ways including a first way and a second way;
a communication section; and
a control section, wherein:
when the button is pressed while the communication section connects to a server through a network and the detection section detects that the button is pressed in the first way, the control section stores address of the connected server in the storage region corresponding to the pressed button; and
when the button is pressed and the detection section detects that the button is pressed in the second way, the control section reads out address stored in the storage region corresponding to the pressed button and the communication section connects to a server having the read-out address.

33. A voice record and reproduction apparatus, comprising:
a button;
a memory that has a storage region corresponding to the button;
a detection section that detects which way the button is pressed in, from among predetermined ways including a first way and a second way;
a reproduction section that reproduces voice stored in the memory;
a microphone; and
a control section, wherein:
when the detection section detects that the button is pressed in the first way, the control section store voice input through the microphone in the storage region corresponding to the pressed button; and
when the detection section detects that the button is pressed in the second way, the control section reads out the voice stored in the storage region corresponding to the pressed button and the reproduction section reproduces the read-out voice.
